(19) United States
(12) Patent Application Publication
(10) Pub. No.: US 2014/0129357 A1
(43) Pub. Date: May 8, 2014

(54) INTELLIGENT PAYMENT SYSTEM

(71) Applicant: Russell S. Goodwin, Singapore (SG)

(72) Inventor: Russell S. Goodwin, Singapore (SG)

(21) Appl. No.: 14/127,947

(22) PCT Filed: Jul. 27, 2012
(86) PCT No.: PCT/SG2012/000272

§ 371 Date: Dec. 19, 2013

(30) Foreign Application Priority Data
Jul. 27, 2011 (SG) 201105413-7

(51) Int. Cl. G06Q 20/20; G06Q 20/22

(52) U.S. Cl. CPC G06Q 20/20; G06Q 20/227
USPC 705/16

(57) ABSTRACT

The present invention provides an intelligent payment system for an automated payment method selection in a payment transaction for a user. The intelligent payment system comprising an electronic device, wherein the electronic device that includes a mobile phone or a portable electronic device, wherein the electronic device is operably used to initiate the payment transaction; a merchant-to-processor module locating at a merchant, wherein the merchant-to-processor module operably transmits a payment request to the electronic device; a remote server for containing a database of information in relation to promotional offers, rewarding schemes, transaction, incentives offering by various financial institutions and/or merchants, wherein the remote server is accessible by the electronic device to transmit the payment method thereto; and a plurality of rule sets defining rules and criteria for evaluating and determining a best payment method for payment transaction; wherein upon receiving the payment request from the merchant-to-processor module, the payment request is processed based on the rule sets and the database to determine the best payment method for the payment transaction, wherein the best payment method is output on the electronic device.

### FIELD OF THE INVENTION

The present invention relates to a system and method of providing an automated payment selection capability for payment transactions using an electronic device.

### BACKGROUND

Increasingly, competitiveness between financial institutions has resulted in a wide variety of new financial products or packages created by financial institutions to attract customers. Among other facilities, bank credit facilities, such as credit cards, are often packaged with attractive promotional offers, reward systems, cash back incentives, gift vouchers and the like. Often, these enticements are tied up with respective merchants, retailers and businesses to encourage use of payment products for specific facilities. Accordingly, an individual customer may possess many of these facilities from various financial institutions in order to enjoy these enticements.

With the large variety of available payment facilities on hand, it may be difficult for a consumer to identify which facilities to use at the point of sale for the best benefit. While sales personnel may be able to advise on currently available incentives with the respective facilities, the advise may not always be reliable in choosing a best facilities that is able to offer the best possible rewards for the consumer. Such rewards are often presented for the benefit of the business and not always for the consumer.

US Patent Application published as US2008/0167017 discloses a method for managing mobile payments in a mobile phone. The method includes receiving data associated with a plurality of issuer specific payment services at a mobile phone, selecting one of the issuer specific payment services, and conducting a transaction using the mobile phone. The method further includes an offer engine that allows consumers to redeem an offer (coupon, discount, promotion etc.) that may be delivered in a suitable message format on the mobile phone.

US Patent Application US2008/0121687 discloses a system and method for a contact-less transaction validation suitable for use in a mobile device through near field communication (NFC). The system includes an NFC application for monitoring data communication and an NFC-Universal Integrated Circuit Card (UICC) toolkit application for providing proactive command support to the mobile device. Similarly, the NFC-UICC application that stores data and banking information associated with one or more credit cards and also allows the user to select a credit card for the contact-less transaction.

### SUMMARY

In one aspect of the present invention, there is provided an intelligent payment system provided for an automated payment method selection in a payment transaction for a user. The intelligent payment system comprising an electronic device, wherein the electronic device that includes a mobile phone or a portable electronic device, wherein the electronic device is operably used to initiate the payment transaction; a merchant-to-processor module locating at a merchant, wherein the merchant-to-processor module operably transmits a payment request to the electronic device; a remote server for containing a database of information in relation to promotional offers, rewarding schemes, transaction, incentives offering by various financial institutions and/or merchants, wherein the remote server is accessible by the electronic device to transmit the payment method thereto; and a plurality of rule sets defining rules and criteria for evaluating and determining a best payment method for payment transaction; wherein upon receiving the payment request from the merchant-to-processor module, the payment request is processed based on the rule sets and the database to determine the best payment method for the payment transaction, wherein the best payment method is output on the electronic device.

In one embodiment, the rule set comprises a local rule set, wherein the local rule set is stored in the electronic device; and a server rule set, wherein the server rule set resides in the remote server. The local rule set is updated from the server rule set.

In another embodiment, the merchant-to-processor module operably communicates with the electronic device wirelessly to transmit the payment request. The electronic device communicates with the merchant-to-processor module through a contactless communication technology such as near field communication.

In yet another embodiment, the intelligent payment system further comprises a stored data module for storing data and information associated to a plurality of payment evaluation criteria and results from previous payment transaction, and a location assisted input for providing data inputs that includes a geographical location obtained through a positioning system, wherein the information stored in the stored data module and obtained from the location assisted input is used as evaluating criteria for determining a best payment mode. The plurality of payment evaluation criteria includes a user-defined type, a server-defined type, an analytics defined type, and a Point of Sale (PoS) type. The payment evaluation criteria provide data and information that the user inputs via a direct user interface.

In yet another embodiment, the direct user interface is a local application that includes a user-specific profile created on the electronic device or a web portal. The direct user interface is provided for the user to access, and input data and information associated to the payment evaluation criteria. The direct user interface operably communicates with the remote server and the stored data module to provide the data and information input by the user.

In another embodiment, the intelligent payment system further comprises a payment decision engine. The payment decision engine resides locally on the electronic device for processing the payment request based on the rule sets and the stored data module to determine a preferred payment method. The payment decision engine activates a fallback payment method when it is unable to determine a preferred payment method from the rule sets and the stored data module. The fallback payment method is defined by the user or determined from the remote server.

In another aspect of the present invention, the intelligent payment system may further be deployed wirelessly at a plurality of payment points via the electronic device, wherein the payment points include a computer and a self-service payment kiosk or a media device such as an internet connected television

### BRIEF DESCRIPTION OF THE DRAWINGS

This invention will be described by way of non-limiting embodiments of the present invention, with reference to the accompanying drawings, in which:

FIG. 1 illustrates a block diagram of an intelligent payment system as one embodiment in the present invention;

FIG. 2 exemplifies a process-flow diagram of the intelligent payment system;

FIG. 3A illustrates a process-flow diagram of the intelligent payment system in greater detail;

FIG. 3B exemplifies the communication between the user and the intelligent payment system as shown in FIG. 3A;

FIG. 3C exemplifies the communication between the intelligent payment system and the payment method process as shown in FIG. 3A;

FIG. 3D exemplifies the communication between the payment method process and the server-side, and between the intelligent payment method and the server-side as shown in FIG. 3A;

FIG. 4A is a schematic illustration of portions of a representative ordered payment method list, which can be presented by a payment method selection or transaction decision GUI, for a representative purchase at Retailer X;

FIG. 4B is a schematic illustration of portions of another representative ordered payment method list, which can be presented by a payment method selection or transaction decision GUI, for the representative purchase at Retailer X;

FIG. 4C is a schematic illustration of portions of a representative ordered payment method list, which can be presented by a payment method selection or transaction decision GUI, for a representative purchase at Retailer Y; and

FIG. 4D is a schematic illustration of portions of another representative ordered payment method list, which can be presented by a payment method selection or transaction decision GUI, for the representative purchase at Retailer Y.

### DETAILED DESCRIPTION

The following descriptions of a number of specific and alternative embodiments are provided to understand the inventive features of the present invention. It shall be apparent to one skilled in the art, however that this invention may be practiced without such specific details, or with variations thereto. Some of the details may not be described in length so as to not obscure the invention. Examples provided herein are nonlimiting representative examples provided for purpose of illustration to aid understanding. Numerical values provided in association with such examples are representative and/or approximate values, unless explicitly stated otherwise. For ease of reference, common reference numerals will be used throughout the figures when referring to same or similar features common to the figures.

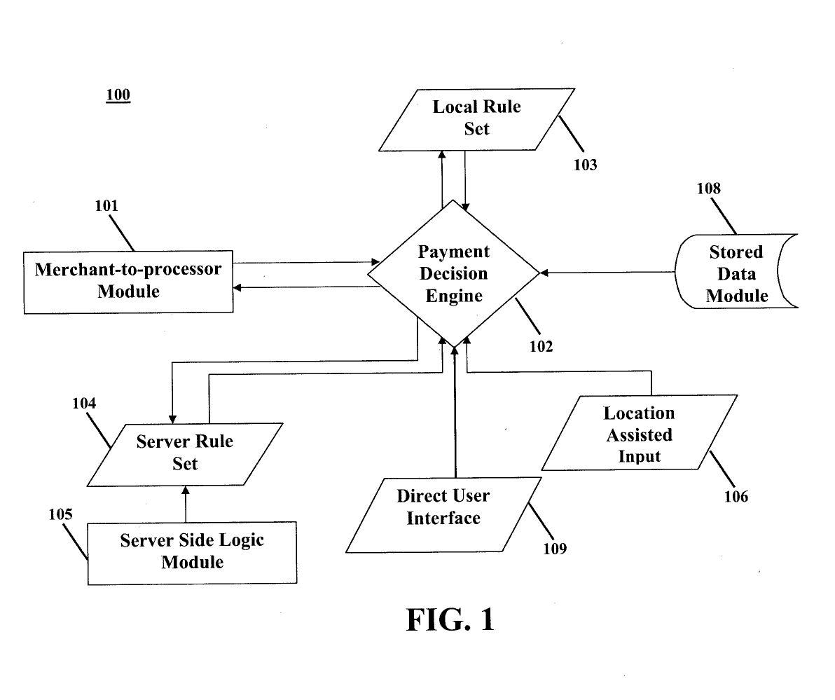

FIG. 1 illustrates a block diagram of an intelligent payment system 100 as one embodiment of the present invention. The intelligent payment system 100 is adaptable to work with a user's electronic device for automating a preferred possible payment method according to the user's interest. The payment method is used for a payment transaction initiated by the user with a merchant. The user includes a customer or any individual who owns one or more payment options from a variety of financial institutions or payment card providers. The electronic device includes a mobile phone, portable electronic device, or the like. The merchant may include a Point of Sale (PoS) merchant (e.g. restaurants, clothing store), an online merchant (e.g. blogshops, online stores) or a payment intermediary. The point of sale may refer to a retail premise or location, an electronic retailer such as a web site, or a point of sale situated in a users home such as an Internet enabled television, a personal computer or other such equipment. It may also include other payment locations such as ticketing points, tolls or such places as electronic payments are made.

The intelligent payment system 100 comprises a merchant-to-processor module 101; a payment decision engine 102; a local rule set 103; a server rule set 104; a server side logic module 105; a location assisted input 106; a stored data module 108; and a direct user interface 109. The payment decision engine 102 may be available to the user's electronic device, either as a software application resided locally on the electronic device or located remotely over a data connection. In the case where the payment decision engine 102 resides on the user's electronic device, the local rule set 103 is stored in the user's electronic device and accessible directly by the payment decision engine 102. The merchant-to-processor module 101 is generally located at the merchant side and communicates with the payment decision engine 102 through the user's electronic device. It is desired that the payment decision engine 102 residing in the user's electronic device and the merchant-to-processor module 101 communicate through a wireless communications, such as near field communication (NFC) technology or the like. The server rule set 104 is dynamically updated from the server side logic module 105, which runs on a remote server. It is also desired that the user's electronic device is able to communicate with the remote server so that the payment decision engine 102 is accessible the server rule set 104. The data exchange between the user's electronic device and the remote server can be carried out through communication means, preferably wireless communication means, such as 3rd generation mobile telecommunications (3G), Wi-Fi or the like. The location-assisted input 106 provides location information of the user's electronic device to the payment decision engine 102. This is to provide input on relevant information such as a country's location as well as to improve the analytics data captured. The stored data module 108 stores data and information related to the user, available payment cards as well as data regarding transactions that can be passed to the server side logic module 105 for inclusion in payment decisions and analytics. The data and information are also accessible by the payment decision engine 102 for payment processing. The direct user interface 109 is a local application that includes a user-specific profile created on the user's electronic device or a web portal. The user accesses the direct user interface 109 and inputs all the data and information into the user-specific profile as required by the intelligent payment system 100. The direct user interface 109 operably communicates with the server side logic module 105 and the stored data module 108 to provide the data and information. The user interface 109 is also used for user prompted input.

The server side logic module 105 may have data communication with the financial institutions to acquire updates on variables that affect payment choices. These data from the financial institutions can be an additional input to data that is collected and stored in the remote server. The data may be collected via research. Examples of data collected are public information on web sites or in product terms and conditions, press or publicity information or information provided directly by payment card, ticketing or voucher companies.

The server side logic module 105 also considers all the data input from the stored data module 108 to evaluate the preferred payment method. Once the preferred payment method is determined, the preferred payment method is updated in the server rule set 104 and is provided to the payment decision engine 102. The server rule set 104 is also updated regularly by the server side logic module 105 whenever there are changes or updates in the promotional packages, payment product details or offers from the payment card providers.

In another embodiment of the present invention, the server rule set 104 can either be pushed to the payment decision engine 102, or pulled by the payment decision engine 102 to update the local rule set 103. The updated local rule set 103 provides the same end result for future similar payment requests. The server rule set 104 is updated when criteria change that would affect the payment method decision process and changes are either pushed to the local rule set 103, or are requested by the payment decision engine 102 on the user's device. The process to push or pull of the local rule set 103 may be influenced by access to data and other influences, such as a desire to delay updates due to expensive roaming charges. Keeping the local rule set 103 allows the intelligent payment system 100 to determine a preferred payment method with lower latency and when there is no network access (e.g. when the server side logic module 105 is non-accessible, and etc).

In a further embodiment, the user's electronic device may not always have wireless communication with the remote server. Therefore, the local rule set 103 may be updated at scheduled intervals or on an ad-hoc basis. This process may be driven by a schedule, availability of data connectivity or a combination of the two.

The local rule set 103 is evaluated with the payment request to identify the preferred payment method for the user. The local rule set 103 is derived from a generated rule set created on the server side logic module 105. It is a set of rules that is created using various inputs, including the data and information from the server side logic module 105 and the payment evaluation criteria. The local rule sets 103 may also contain actions based on location data, such as preferring a certain payment method at a certain PoS.

The local rule set 103 and the server rule set 104 is also desired to contain data with an expiry criteria. Expiration of data will allow a time-limited payment decision data, such as offers to expire without access to network. Expiry data can also be used to ensure that stale data is removed if a connection is not made to synchronize the server rule set 104 within a defined period. Expiry data will generally be defined in the server side logic module 105 and then stored in the remote server, the local rule sets 103 or in the stored data module 108 in the electronic device.

If the payment decision engine 102 is unable to identify a locally preferred payment method and there is no access to the server side logic module 105 to provide the server rule set 104, a fallback payment method stored in the electronic device may be activated. The fallback payment method may be associated but it is not limited to the data input from the location assisted input 106, and provides the payment decision engine 102 a payment method to use if no other matches are found in the local rule set 103. The fallback payment method may be one determined from the server side logic module 105 or defined by the user, or it may be a mixture of both. For example, a payment method may be determined by the server side logic module 105 but is influenced by the payment evaluation criteria as provided by the user. In another embodiment, the fallback payment method may simply be a selected payment method selected by the user. For example, the user may set a specific credit card to be used as the fallback payment method.

The location assisted input 106 provides data inputs that includes a geographical location obtained through a positioning system, such as a Global Positioning System (GPS), a wireless access point or any other known positioning systems. The geographical location can be used by the payment decision engine 102 as one of the payment evaluation criteria in deciding the best payment mode. In the event that the location assisted input 106 is unable to obtain the data inputs from the positioning system, the location assisted input 106 obtains data based on a last known location. For example, a saved merchant information (the merchant information has been utilized in the past), or on the information previously provided by the merchant-to-processor module 101 may be used to determine the last known location.

The stored data module 108 gathers and stores information related to the user, available payment cards as well as data regarding transactions that can be passed to the server side logic module 105 for inclusion in payment decisions and analytics. The data and information are also accessible by the payment decision engine 102 for payment processing.

Data and information may further be provided by various sources (e.g. remote server, direct user interface 109, etc.) according to a plurality of payment evaluation criteria. The payment evaluation criteria are assessed to assist the payment decision engine 102 and passed to the server side logic module 105. The data may include transaction data, merchant data, payment method acceptance data or instances of user interaction with the payment decision on the electronic device (e.g., when a user selects to override or intervene with the recommended payment selection). The payment evaluation criteria may include a user-defined type, a server defined type, an analytics defined type, and a Point of Sale (PoS) type.

In the user-defined type criteria, the user may define many criteria to assist in the payment decision. The user inputs all the relevant or required data accordingly to the user-defined type criteria in the profile. As the user inputs more data, the evaluation of the type of payment method suggested to the user will be better. The user-defined type criteria may include but not limited to the following: available payment methods; available credit or balance limits on the payment methods; user-defined manual payment rules; and user-defined targets or goals.

In the available payment methods, the user inputs the various types of payment methods that he or she have. This may include a variety of credit or debit payment cards, travel cards or payment vouchers that the user may have access to. In the available credit or balance limits on the payment methods, the user defines the limits of the various payment methods in the profile accordingly. In the user-defined manual payment rules, the user may define a specific payment method to use during specific instances. In the user-defined targets or goals may include the following: a spending target limit; a preferred reward type, such as mileage points, cash back rebate, etc.; a preference to increase cash flow for a payment method; an interest rates and repayment dates information of the various payment methods; a lowest cost card; a preference to use bonus or introductory offers of a payment method; a preference to use a payment method that has a most value for money, wherein the most value for money is determined based on a scoring evaluation by the server side logic module 105; a preference to balance the usage of the payment methods equally; a preference to use a payment method to maximize a credit score (e.g. to use payment methods that support credit scores); and a preference to use a payment method that first meets the user-defined goals and targets.

In the server defined type criteria, the criteria are incorporated in the server side logic module 105 to assist the payment decision in the payment decision engine 102. The server defined type criteria may include but not limited to the following: payment types; interest rate; payment brands; payment card providers; offers and bonuses; and partner and merchant discounts or offers as well as payment acceptance and location information.

The server defined type criteria are obtained via the remote server from the corresponding financial institutions, etc. In the payment type, the payment type may include credit or debit cards, travel cards, electronic vouchers or other forms of e-cash etc. In the payment brand, the payment brand includes Visa, MasterCard, and etc. In the payment card provider, the payment card providers are those financial institutions offering the payment facilities under the payment brand. In the offers and bonuses, the various financial institutions having different offerings (e.g. mileage points, cash back rebate) are provided. In the partner and merchant discounts/offers, the server may obtain the updated or available discounts or offerings from the merchants. These may include but not limited to discounts, rebates, vouchers, bonus, offers, promotions or the like.

In the PoS type criteria, the data is input during the evaluation process about the location and type of transaction. This data is used by the payment decision engine 102, in conjunction with the local rule set 103 to make the best payment decision. Additionally, the data may be transmitted to the server side logic module 105 to be used by the analytics to further improve the decision process. If access to the server logic module 105 is not available, then the data may be stored in the stored data module 108 for transmission later. The PoS criteria may include but not limited to the following: geographical location; acquirer information; merchant information; date or time information; currency; and PoS or merchant provided information, such as offers or electronic vouchers.

In the geographical location, information of user's location is provided (e.g. the country, place, and etc.). In the acquirer information, the information includes a type of transaction processor that is processing the transaction. In the merchant information, the information includes name of the merchant and the type of the merchant's business. In the date or time information, the date and time of the transaction is provided. In the currency, the type of denomination for the transaction (e.g. US dollar, Japanese Yen) is provided. In the PoS or merchant provided information, the various offerings, discounts, advertisements, and etc. may be provided.

In the analytics defined type criteria, the criteria assists the payment decision based on the user's target or goals defined in the user-defined type criteria. The data inputs in these criteria are analyzed in the server side logic module 105 to identify the preferred payment method of the user and why the payment method is preferred. The analytics defined type criteria may include but not limited to the following: black and grey list data; automated selection of payment method; user backlog information; and approval request.

In the black and grey list data, the user or the server side logic module 105 inputs a payment location into a black list or a grey list. The black list includes a list of locations black listed by the user. The grey list includes a list of locations defined by the user or identified by the server side logic with specific criteria. The location may be black listed for several reasons as desired by the user. The user may also remove the locations from the black list or the grey list whenever preferred. In the automated selection of payment method, the user may define that the locations listed in the grey list use a certain payment method that is automatically selected as the preferred payment method. In the user backlog information, previously preferred payment method is stored in a history of payment methods that have been used previously. In the approval request, the user may prefer to first approve the payment method prior to making the payment transaction. Additionally, the grey or black list may be utilized to help prevent fraudulent transactions. For example if a certain location or PoS is known to suffer from, or contribute to a high level of fraud, then the electronic device can recommend that cash is used and that a payment card is not offered. This may help to reduce card fraud that a user is subjected to and alert a user to potentially risky Points of Sale.

All the individual data inputs from the payment evaluation criteria are useful information. However, these data input becomes valuable when assessed in the server side logic module 105. The more data that is collected, the more valuable the analytical data produced, both in terms of offering users the best decision but also in terms of value to payment providers.

Based on all the data inputs from the payment evaluation criteria, the payment decision made by the payment decision engine 102 may be suggested to the user through the electronic device as the preferred payment method. In another embodiment of the present invention, the user may select the payment method themselves from a list of payment methods. The user may then enable the electronic device to execute the selected preferred payment method (or preferred payment method) with the merchant to complete the payment transaction. The electronic device may also present a manual selection along with a “recommended” tag to inform the user as to the payment method that would be chosen, should the payment decision be automated. This can provide the user the flexibility to use a manual payment selection but also provide information that the user may find useful.

The intelligent payment system 100 may also be applied as a payment intermediary process, or by an implementation of a mobile payment technology at a user end point. The payment intermediary process includes transactions or payment requests completed over the Internet website. Such payment requests may also require the user to complete payment details at the time of transaction. It is optional whether the payment decision engine 102 acts as a broker or a referrer to the payment intermediary process, i.e. data and information from the server side logic module 105 may or may not need to be accessible to the payment decision engine 102. Being the broker provides greater visibility of the results of the payment transaction but may attract certain regulatory requirements. Payment details may include the data input from the payment evaluation criteria.

Further, the payment intermediary process may be implemented as an end user client or a server side client. The end user client's payment decision engine 102 identifies a remote point of sale and runs the local rule set 103, in conjunction with other data, such as merchant location based information to identify the preferred payment method. The end user client may be a standalone client or a plug-in to the Internet browser to the end user's device. The source of identification may be directly in-line with the Internet browser interaction, or by the user defining a transaction detail, this may include such detail as retailed information, value of transaction and the date the payment will be made, prior to the suggestion of the preferred payment method. The server side client implements the server side logic module 105 as a “payment processor” service. A payment method selection is made by the user as a “payment logic” service, and the server side logic module 105 interacts with the server over a secure connection to identify the user and the PoS information. This creates a rule set result calculation of the end result that is returned to the user or to the Internet website directly. Further, payment details that may be required by the user or the Internet website may also be completed. This is similar to the interaction between the user's electronic device and the server side logic module 105 as discussed earlier.

The intelligent payment system 100 may further be deployed at a plurality of payment points adapted with a wireless technology such as NFC via the electronic device. Examples of the payment point include a computer, a self-service payment kiosk and from any electronic point of sale equipment that may reside in a users home. These home based electronic point of sale systems may include hand held devices, tablets, computers or interne connected house hold appliances, such as televisions, fridges or similar. The use of wireless technology such as NFC via the electronic device allows contactless payment transactions to be made at an electronic or online merchant in the same way as a physical point of sale. Security of the actual payment is handled by the wireless technology deployed, such as NFC technology, and the payment method selection works as if the user were at the point of sale.

The intelligent payment system 100 is activated when the user initiates the payment transaction via the electronic device at the merchant's point of sale counter. The payment transaction can be activated by placing the electronic device close to the merchant-to-processor module 101 so that the electronic device can communicate with the merchant-to-processor module 101 through NFC. Once the NFC is established, the merchant-to-processor module 101 transmits a payment request to the payment decision engine 102. The payment decision engine 102 processes the payment request based on data from the local rule set 103, the server rule set 104, the location assisted input 106, and the stored date module 108 to determine a preferred payment method. Once the preferred payment method is determined, the payment decision engine 102 then transmits the necessary data in association with the preferred payment method to the merchant-to-processor module 101 for processing the payment transaction. If desired, user interaction can be included in the process.

For simplicity, the terms “payment card” or “credit card” are provided herewith for illustration only, not limitation. The present invention is adaptable for any non-cash or e-cash transactions, which also include charge card, ticketing or electronic voucher facilities. Desirably, it is adapted as digital wallet system for electronic commerce transactions. It is suitable for adaptation on digital wallet systems utilize wireless technologies such as Near Field Communication (NFC) for carrying out the payment transactions. Further, the present invention is also adaptable in any electronic payment facilities, such as those provided by third parties.

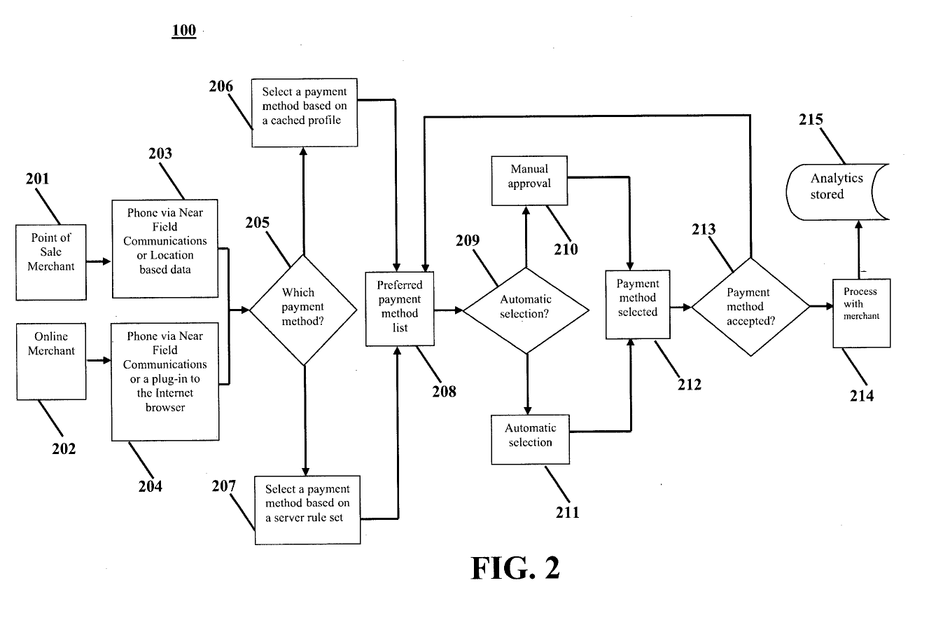

FIG. 2 exemplifies a process-flow diagram of the intelligent payment system 100. A user may first request to make a payment transaction with a PoS merchant in step 201 or with an online merchant in step 202. In step 203, the PoS merchant communicates with the user's electronic device via NFC technology or a similar wireless mechanism. In step 204, the online merchant communicates with the user's electronic device via a wireless technology such as NFC or an online interface, such as a plug-in to the Internet browser on the end user's electronic device. After step 203 or step 204, the intelligent payment system 100 determines which payment method should be suggested to the user in step 205. This can then be executed automatically, or may be used in conjunction with the input from the user, depending on preferences set.

In step 206, the intelligent payment system 100 selects a payment method based on a cached profile. The cached profile may be the local rule set 103 derived and created from the server rule set 104 with the data input from the stored data module 108. In step 207, the intelligent payment system 100 selects a payment method based on the server rule set 104, which is derived from the server side logic module 105. The selected payment methods from step 206 and step 207 are added in a list of preferred payment method in step 208.

In step 209, the intelligent payment system 100 assesses the data inputs from the payment evaluation criteria and checks if the user has defined a preferred payment method that is found in the list of preferred payment method from step 208. If the user has not defined a preferred payment method in the list of preferred payment method from step 208 and the local rule set 103 includes a preference for manual intervention, the intelligent payment system 100 seeks a manual approval from the user in step 210. If the user has not defined that manual interaction is required and a preferred payment method in the list of preferred payment method from step 208 can be identified as a best payment method, the intelligent payment system 100 automatically chooses the preferred payment method in step 211. After the user has manually approved a payment method in step 210, or after the intelligent payment system 100 automatically chooses the payment method in step 211, the payment method is selected in step 212 and used to execute the payment.

After the payment method is selected, the intelligent payment system 100 checks if the Point of Sale accepts the payment method in step 213. If the Point of Sale does not accept the selected payment method in step 213, the process returns to step 208 through step 213 until the payment method selected is acceptable.

Once the payment method selected is accepted, the payment method selected is processed with the merchant to complete the payment transaction in step 214. Thereafter, the intelligent payment system 100 stores the payment method selected as an analytics data in step 215, and also records information regarding any user interaction or payment method failures that occurred so that the information can be used by the server side logic module 105. This data is stored in the stored data module 108 and passed back to the server side logic module 105 when appropriate.

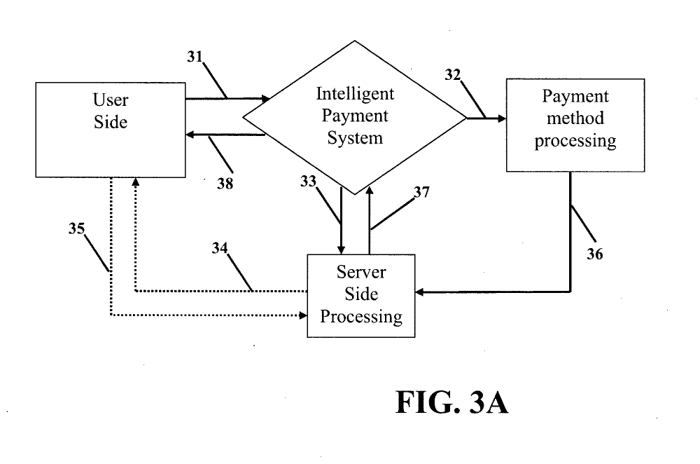

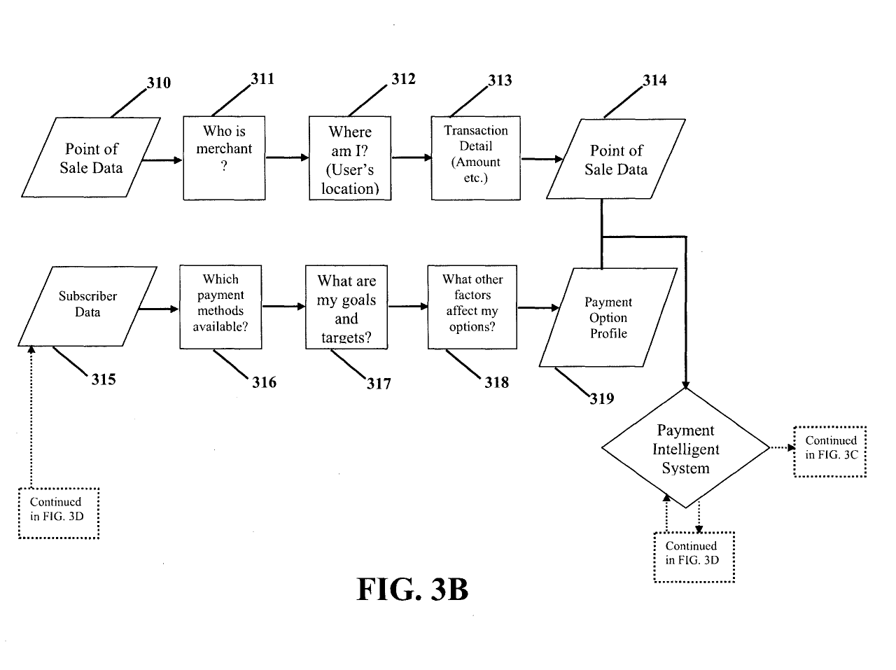

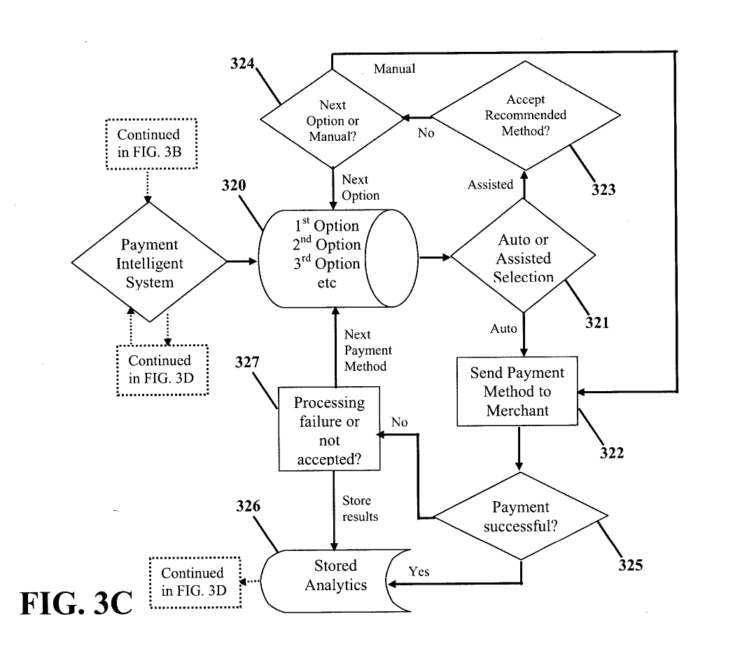

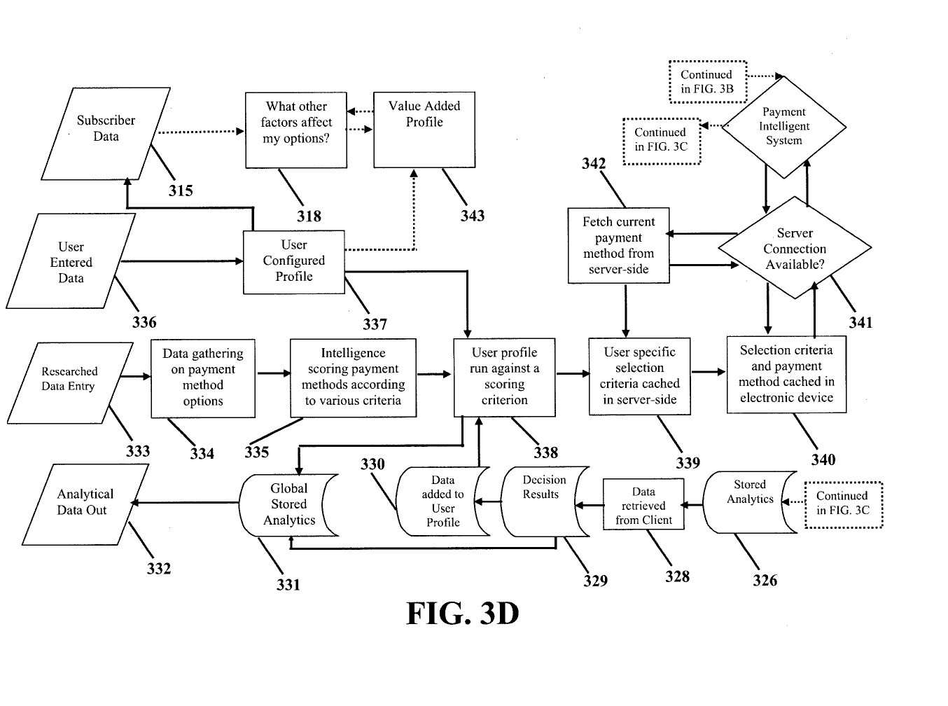

FIG. 3A provides an overall illustration of the intelligent payment system 100 communicating with a user, a server-side and a payment method process. The intelligent payment system 100 communicates with the user through the direct user interface 109 located in the user's electronic device in step 31 and processes the payment method within the electronic device in step 32. The intelligent payment system 100 also communicates with the server-side via a data network in step 33. The server-side provides information to the intelligent payment system 100 in step 37. Information from the server-side may also be provided to the user in step 34, or the user may also input data to the server-side in step 35. After the intelligent payment system 100 processes the payment in step 32, the result is stored in the electronic device's stored data module 108 and sent to the server-side in step 36. The result includes data regarding attempted, successful or failed transactions.

FIG. 3B exemplifies the communication between the user and the intelligent payment system 100. The user is provided a Point of Sale (PoS) Data input through the direct user interface 109 in steps 310-313. The PoS Data includes information on a merchant, a user's location, and a payment transaction detail. In step 311, the information is collected on the merchant including such details as the merchant's name and merchant number. In step 312, the user's location may include such details as a country or other geographical data. In step 313, the payment transaction detail includes the payment transaction amount, and a type of goods and/or services to be provided. In step 314, a payment profile data including all the information from steps 310-313 is provided in a Point of Sale profile.

Further, a subscriber's data input is provided in step 315. The data inputs are obtained from the server-side as shown in step 34 in FIG. 3A. In step 316, the payment methods include the various types of payment, credit or debit cards, electronic ticketing or vouchers etc available to the user. In step 317, the user may input data that includes the user's targets and goals. In step 318, the user further provides data inputs associated to a plurality of payment evaluation criteria. The data input associated with the plurality of payment evaluation criteria is also stored in the server-side as shown in step 35 in FIG. 3A. Data may be input by the user via a variety of methods, including, but not limited to a web portal, via the direct user interface 109 or even via a telephone help desk. In step 319, a payment option profile data that includes all the information from steps 315-318 is provided.

The information in the payment profile data in step 314 and the payment option profile data in step 319 is collated and provided to the intelligent payment system 100 as shown in FIG. 3B.

FIG. 3C exemplifies the communication between the intelligent payment system and the payment method process as shown in step 32 in FIG. 3A. The intelligent payment system 100 processes the payment methods available and lists the payment methods accordingly in step 320. In step 321, the intelligent payment system 100 decides if the payment method is selected automatically or should be assisted by the user based on the user's data input in the payment evaluation criteria.

If the user prefers the automated selection of the payment method, the payment method is sent straight to the merchant in step 322. If the user prefers to assist in the payment method selection, the user is asked if the payment method recommended by the intelligent payment system 100 is acceptable in step 323. If the payment method recommended is not acceptable to the user, step 324 asks if the next payment method option in the list of payment methods from step 320 is to be shown, or if a payment method from the list of payment methods is to be manually selected. If the user prefers to manually select a payment method from the list of payment methods, the manually selected payment method is then sent to the merchant in step 322. If the user prefers to be shown the next payment method option, steps 320-321 are repeated till a payment method is selected and sent to the merchant in step 322.

Step 325 checks if the payment method sent to the merchant is successful. If it is successful, the payment method is stored in the stored data module 108 in step 326. If it is not successful, step 327 checks if the payment method is not accepted or if there is a failure in the processing of the payment method. The results from step 327 are stored in the stored data module 108 in step 326 and another payment method from the list of payment methods in step 320 is used. When another payment method is to be used, steps 320-321 is repeated till a payment method is sent to the merchant in step 322. If a failure occurs in step 327, the process is repeated until a success occurs in step 325 or the process is halted as it runs out of option from the list of payment methods. If options run out, the user is presented with an appropriate notification.

FIG. 3D exemplifies the communication between the payment method process and the server-side in step 36 and between the intelligent payment system 100 and the server-side in step 33 and 37, as shown in FIG. 3A.

After the results from steps 325 and 327 are stored in step 326, the data from the results are retrieved in step 328. In step 329, the user specific results are retrieved and added to a user's profile in step 330 and to a global stored analytics in step 331. Data from the global stored analytics are therefore output from an analytical data output in step 332.

In step 333, a research data entry is input from the server-side and the data is gathered on the payment methods in step 334. In step 335, intelligent scoring of the payment methods according to the plurality of payment evaluation criteria is provided. In step 336, a user-entered data is input into a user-configured profile in step 337.

All the data obtained from steps 333-335, step 330 and steps 336-337 are therefore processed with the user's profile and are evaluated against a scoring criterion in step 338. Thereafter, a user specific data input associated to the plurality of payment evaluation criteria and payment method is stored in the server-side in step 339. These data input and payment method are then stored in the user's electronic device in step 340. Further, the results from step 338 are stored in the global stored analytics in step 331.

When attempting to process a payment In step 341, the intelligent payment system application 100 running on the user's electronic device checks with the server-side logic module 105 if there is an available server connection and compares the server rule set 104 and the local rule set 103 to verify if the local rule set 103 is current. If connectivity is available, the server rule set 104 is retrievable and the server rule set 104 is newer than the local rule set 103, a current payment method order is fetched from the server side logic module 105 in step 342. The current payment method is retrieved from step 339. Thereafter, the result is transmitted through the server connection in step 341 and sent to the intelligent payment system 100. If there is no server connection or if the local rule set 103 is current, the data input and payment method stored in the user's electronic device in step 340 is retrieved and the result is used by the intelligent payment system 100 to enable the decision process.

Further, the data input from the user's configured profile in step 337 is provided to the subscriber's data input in step 315 and to a value added profile in step 343. The value added profile includes information provided by the user from step 318. This data is output and contributes to the payment option profile.

### Aspects of Representative Transaction/Payment Method Decision Processing

When a transaction request is received by the user's electronic device (e.g., the user's mobile telephone, tablet or note-type computer, or other device), the electronic device (e.g., software executing on the electronic device configured for facilitating an automated or semi-automated payment method selection process), which can include or be the payment decision engine in some embodiments) first refers or attempts to refer to a locally cached rule set (i.e., a cached local rule set stored on the electronic device) to determine if a cached payment method for the transaction amount and/or merchant/PoS under consideration exists within the locally cached rule set. The electronic device can additionally determine whether the server side logic module 105 is available (e.g., whether communication with the server side logic module 105 can be established). If a locally cached rule set does not exist, and the server side logic module 105 is not available, the electronic device can present or output a fallback payment method recommendation to the user, in order to ensure that a payment method or mode is presented or selected/selectable in a timely manner when a pre-cached payment method does not exist or server side logic module 105 communication cannot be established.

If no locally cached rule set exists, and communication with the server side logic module 105 is successful, the electronic device sends a request to the remote server to determine at least one payment method (e.g., a preferred, recommended, expected best, or expected most suitable payment method) for the transaction presently under consideration. In response to such a request from the electronic device, the server side logic module 105 examines the server rule set to determine if a payment rule exists corresponding to a preferred payment method for the transaction. If so, the server side logic module 105 returns the payment rule and/or the preferred payment method to the electronic device. The server side logic module 105 can additionally or alternatively return the server rule set to the electronic device. In association with receipt of the payment rule or the server rule set, the electronic device can store an updated/cached local rule set.

In the event that no server side payment rule exists in the server rule set, the server side logic module 105 determines the best payment method for the present transaction in association with a payment method selection process, which considers information or data including transaction related information (e.g., transaction amount, date/time, and type), merchant related information, user-defined type criteria, server defined type criteria, and possibly other information to determine a list of payment methods, options, or alternatives, including a recommended or expected best payment method, where such a list can be a prioritized list of payment methods in order of preference (e.g., which can be based upon or be organized in accordance with expected best to expected least benefit; or expected lowest cost to expected highest cost; or expected highest award/bonus to expected least award/bonus or least penalty to the user).

If a locally cached rule set or a server rule set exists, the electronic device or the server side logic module 105 can respectively also determine whether associated date/time criteria exist, which can indicate whether (a) the locally cached rule set is stale (e.g., older than a selectable or predetermined number of hours, days, or weeks); and/or (b) one or more rules include or specify date/time usage restrictions (e.g., validity only on weekdays between 9:00-11:00 A.M.) or expiry criteria (e.g., indicating offer expiration after a certain date). Based upon one or more date/time criteria, a payment method selection process (e.g., portions of a local payment method selection process executed on the electronic device, or portions of a remote payment method selection process executed on the remote server) can selectively exclude one or more rules from consideration during a payment decision process, or purge a number of rules from a rule set.

### Aspects of Representative Comparative Decision Processes

For each transaction, various details can be used to determine a best payment method. For example, a transaction or payment card financial institution may be overseas so one or more possible available payment methods may be charged a foreign transaction charge/fee or a certain exchange rate. Such charges can differ by payment option, payment card provider, financial institution, or card brand. Also, a transaction at a given merchant may attract a card fee, for example, a 0% fee for cash, voucher, coupon or debit card; a 2% fee for Visa; a 2.5% fee for MasterCard; and a 5% fee for American Express.

A given transaction can also attract or be associated with an offer or incentive. This could include, for instance, one or more of a cash discount, a cash back offer, a rebate offer, a loyalty point offer for the merchant, and a loyalty point modifier for a partner. For example, using an American Airlines Amex card may provide a 1 mile per USD reward, but at Macy's department store, there may be an offer to give 1.5 miles per USD. Using the American Airlines Amex card at an American Airlines site may give 3 miles per USD. Such offers can be specific to items, specific retail locations, specific geographical locations, certain transaction values, and/or certain dates/times.

User preferences can also be an input variable into the comparative decision process. For example, a user may prefer to collect American Airlines miles to British Airways (BA) miles, so the American Airlines miles may be associated with or given a multiplier weighting in a rule set. For example, a weighting of 120% may be applied to a certain loyalty point to artificially modify the scoring process to a certain user preferred reward. In one example, the user may be able to collect air miles points for American Airlines, BA and Singapore Airlines. He may have only the American Airlines and BA loyalty schemes available to him, but may prefer the American Airlines scheme. In this case, the American Airlines scheme may be weighted to 120% but the Singapore airlines scheme to 0% to ensure that no matter the possible reward, one is preferred over another.

Scoring of loyalty points can be the result of a payment decision process that considers or includes user preferences as above, as well as other variables. Such variables can include scoring of a given loyalty point to a normalised scoring mechanism, for example, valuing or generating estimated valuations for all loyalty points in USD. This can allow for loyalty points that cannot be directly compared to be relatively scored with respect to each other and/or discounts, offers, promotions, and the like. While it can be straightforward to score two payment options offering BA miles, comparative scoring involving a comparison between the value of a BA mile to an American Airlines mile can involve normalization of a BA mile and an American Airlines mile to a standard reference, benchmark, or unit (e.g., USD or another currency). There can be additional variables or normalizations involved in scoring a BA mile to a Hilton hotel point. By normalising scoring for each possible reward to common value reference, informed comparative or relative scoring decisions and preferred/best payment method selection decisions can be made, for instance, associated with or indicating a ‘best value’ payment method.

In addition to valuing rewards points and modifying the weighting of results based on user-defined type criteria and/or other criteria, additional criteria can be included. For example, points may be transferrable between rewards schemes, so a recursive check can be performed to understand multiple possible permutations among various loyalty reward programs. For example, if supermarket rewards vouchers such as Tesco Clubcard points can be converted to BA miles, and the user owns a Tesco Credit card and a BA credit card, then there may be two possible routes by which the transaction can return BA miles. In such a situation, PoS offers can be included in the decision, such as a “double Clubcard points on Sundays.” The transaction can be evaluated to see how direct BA rewards from the BA card compare to the inferred or converted rewards from using the Tesco card and then converting the vouchers to BA miles. In many cases, the best payment method can be unexpected, surprising, or counterintuitive to the user, who would be unlikely to successfully determine or readily determine a best payment method in the absence of an evaluation in accordance with an automated or semi-automated payment method selection or decision process in accordance with an embodiment of the invention (particularly within an acceptable transaction processing time interval or period, such as a few or several seconds, or less than approximately 10 seconds, or less than approximately 30 seconds). Such a payment method selection process can provide an automatically determined or user selectable result or output (e.g., corresponding to the identification of a preferred/best payment method and/or a relative comparison, ranking, or scoring of available payment methods) to facilitate or enable the completion of a purchase transaction in a brief or relatively brief amount of time that is commensurate with acceptable transaction processing time intervals or periods.

The result of a payment method selection process can also have one or more modifiers applied thereto. For example, a “penalty modifier” can be applied to a Tesco card based payment method. Although the resultant rewards can be converted to BA miles, this takes time and effort; and in some cases cost. Hence, if using the Tesco card and the BA card end up yielding the same or substantially the same number of BA miles, then the BA card should be chosen as it will require less time, effort, or cost to finally arrive at the BA miles. As such a penalty modifier of, for example, 5% may be applied to the Tesco card to ensure the BA card is preferred.

The normalization of a given reward point or reward point scheme can be performed in a variety of manners. Automated, semi-automated, and/or manual research can be conducted on possible practical uses for rewards points, and a value can be arrived at based on how the points can be utilised. For example, if loyalty points can be cashed in for items or gifts, the value of particular items can be used to derive, determine, or estimate the comparative or normalized value of points. If points can be converted into air miles, then the cash value of one or more flights (e.g., domestic flights or international flights corresponding to particular locations) can be used to value the points. This value can also be modified depending on data in the user profile, either input by the user or derived by the server side logic module 105. For example, an average value for a BA mile as expressed in a reference currency may be 0.0212 USD based on an average equivalent value when booking a reward flight with cash. However, if a user is saving points for an annual flight to a given location to visit family during a particular time period (e.g., Christmas time), then the points can be valued or normalized specifically with respect to rewards flights to that location and/or one or more nearby locations during that time period. Similarly, if the user prefers to fly on a reward business class ticket, then the value of the points can change or be appropriately determined/revised again, as it is common for reward business class flights to have a different points mark up versus the cash price equivalent. Such logic can also hold true for a wide variety of loyalty points or point schemes, such as hotel, supermarket, shared loyalty schemes such as the UK ‘Nectar’ scheme, and others.

As such, the valuation put on a certain loyalty point or a loyalty point scheme can be determined in accordance with multiple variables, and the processing of these variables can be completed by the server side logic module 105. These variables can be different per transaction, time of day, location, merchant, user and payment options available. They can also vary depending on current offers and incentives, and other factors.

Once a payment request corresponding to a transaction or potential transaction under consideration has been sent to the electronic device (e.g., a user phone or computing device), some or all the following information can be checked, determined, stored, evaluated, and/or processed in association with a payment method selection process in accordance with an embodiment of the invention:
(a) Who is the merchant or PoS/what is the merchant ID or PoS ID, and what corresponding valid payment options does the user presently have available to them?
(b) Where is the transaction, and if this is a foreign payment, is there any foreign transaction fee and what are the exchange rates provided by the various payment providers available at that time?
(c) Given the identity of the merchant, what are the known offers or incentives offered for this merchant?
(d) Are any of the offers or incentives specific to certain payment options? Which of these are available to the user for the present transaction?
(e) What are the user preferences that relate to this transaction, do they have a user defined rule for this merchant or type of transaction and to they have any grey list information.
(f) Is the merchant or PoS on any server side grey or black lists, for example due to a fraud warning on the PoS/Merchant. If so, the user may be recommended to use a cash transaction to reduce fraud risks on their cards.
(f) What is the value of the transaction? Are any of the offers specific to transaction value (such as a “10% off on purchases over $300”)?
(g) The merchant or PoS may provide information on the contents of the transaction, such as the item description(s) or item brand(s). Are there any offers specific to that item or brand? For example, an offer on Amex cards may be for “10% off of Croc shoes.”
(h) Of the available offers, do time limitations exist? The process can verify the offer hasn't expired, or check if the offer has a specific time window, such as “Saturday's between 10 pm and 11 pm”. Does the transaction fall in the appropriate date/time window, such that the offer can be considered as part of determining the preferred or best payment method?
(i) Are there any partner offers or affiliations, such as “Double BA air miles at BP petrol/gas stations”?

If cards are available in different currencies, then the results can be currency exchange rate normalized to include or account for a measure of different exchange rates and currency fees, and then compared in a common currency, for example, the user's home currency as specified in the user profile, or in the local currency of the transaction.

After some or all of the above are determined, evaluated, or processed, a lowest cost or best value transaction can be calculated. In this respect, multiple offers, rebates, cash backs, incentives, rewards are scored and valued. These values can be modified, depending on server logic evaluation criteria, user preferences, reward weighting criteria/methods, or other factors. Any costs associated with the selection or use of one or more payment methods can also be estimated or scored in, including card transaction fees, overseas usage fees, and foreign exchange rates. Each of these can modify the end cost of the transaction up or down.

A determined or returned result of a payment method selection process can include or be a list of payment methods, ordered or ranked in accordance with payment method advantage to the user or cost/value preference (e.g., an ordered list of preferred payment methods). Such an ordered payment method list can include or specify a number of payment method identifiers (e.g., payment card identifiers, and possibly a cash payment identifier), and possibly corresponding transaction costs, savings, and/or fees, such as in association with a plus or minus value corresponding to the transaction, and possibly a rating or ranking identifier, for instance, as follows:

### Best to Worst Value

Card_A—Rating 1—[−$2.09]
Card_B—Rating 2—[−$1.38]
Card_C—Rating 3—[−$0.27]
Cash—Rating 4—[+/−$0.00]
Card D—Rating 5—[+$0.80]
Card E—Rating 6—[+$3.20]

Such an ordered payment method list can be communicated to the electronic device, which can access, utilize, and/or present the list to facilitate or enable execution of the transaction under consideration. Access or use of the list in association with transaction execution can be an automated process, or the list can be presented to the user, either in its entirety or as a subset for confirmation. Alternatively, the user can be presented with the list and asked to manually select his or her preference. The user can be provided with information on each payment option and its relative ‘valuation’ in a manner such as that indicated above so that an informed choice can be made.

### Aspects of Excluding Currency Fee/Foreign Exchange Fee/Card Charges

In some cases, the user may be travelling abroad on business and covered by expenses. In such a situation, it may be usual for the business funding the travel to pay and accept charges the user incurs during travel. In this case, the user may accept certain card changes related to using a given payment method. Such charges can include card usage fees, foreign exchange rate conversion costs, foreign card usage fees, and the like.

In an embodiment, a payment method selection interface (e.g., a GUI or other type of interface configured for receiving user input) can provide a business transaction mode and/or business travel mode selection on the electronic device. This can be enabled with a toggle switch (e.g., a user selectable visual or graphical switch), for instance, which can be active based upon user preference settings or when the user is traveling (e.g., based upon automatic determination of the user's geolocation); and/or this can be enabled at the time of transaction communication/processing with a graphical pop up element. User selection of such a mode results in a determination of whether particular types of fees will affect or should be excluded from the scoring process, and this requirement may differ per transaction. For example, when paying for a meal for which the cost will be covered by an expense account, the user may prefer a payment card that provides the best rewards for the user, even though some or all of the rewards would ordinarily be offset by fees or charges such as those indicated above. However, if a transaction does not involve a business expense, for instance, if the user is purchasing personal goods or services, the user may prefer such fees to be included in the scoring processes/mechanisms. The provision of a business mode or business travel mode can result in the identification or selection of a particular best, recommended, or preferred payment method even if the payment method does not offer what may ordinarily be the best total value, if the end result to the user provides user benefit (e.g., a greatest level of user benefit in accordance with a rewards or bonus scheme) in view of a business-related transaction, or business-versus-personal transaction.

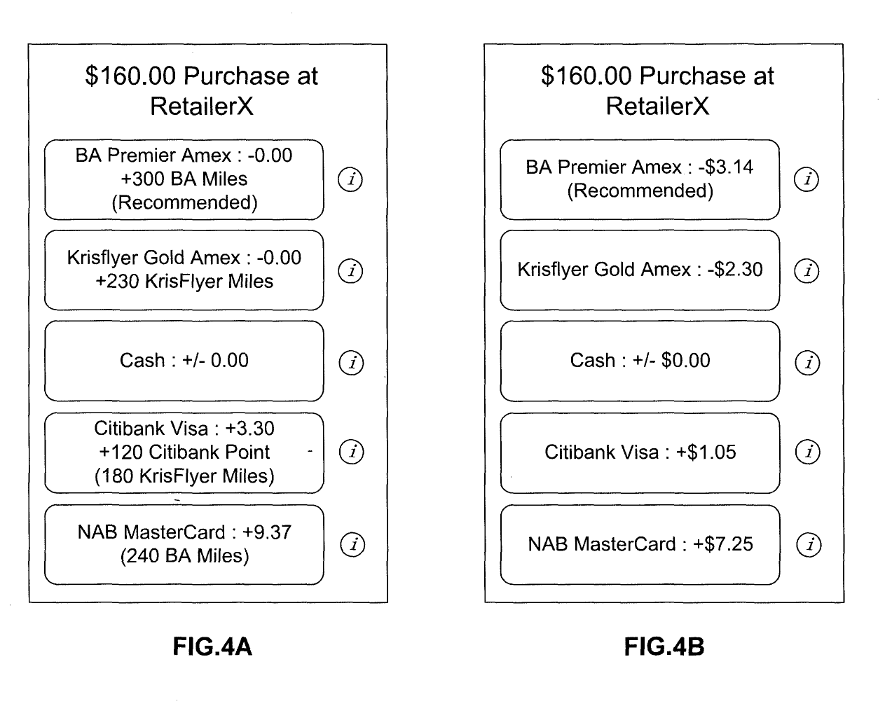

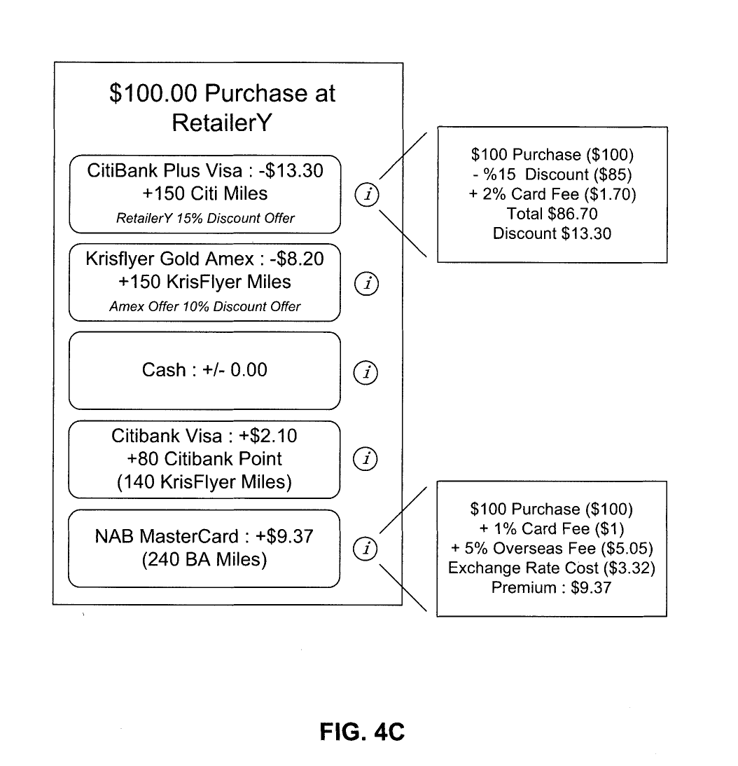

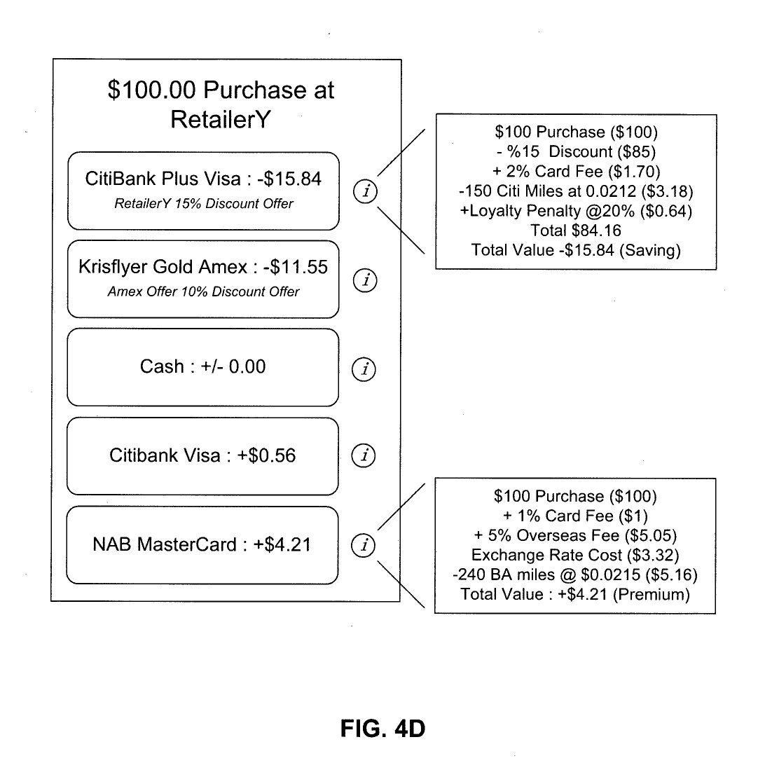

FIG. 4A is a schematic illustration of portions of a representative ordered payment method list, data corresponding to which can be presented by a payment method selection or purchase decision GUI (e.g., configured for execution on the user's electronic device) for a representative purchase at Retailer X. In an embodiment, an ordered payment method list can include or specify an initial, starting, or unadjusted payment amount or price (e.g., $160.00) for the purchase of the item(s), product(s), or service(s) under consideration. The ordered payment method list can additionally or alternatively include a number of payment methods corresponding to payment cards, vouchers, and/or cash. The ordered payment method list can also indicate a total transaction savings or premium amount or value corresponding to a given payment method, for instance, by way of negative dollar amounts to indicate savings that would result, and positive dollar amounts to indicate premiums that would be imposed, upon selection or use of the payment method. The ordered payment method list can further include or specify for each such payment method a corresponding bonus or award, such as a mileage award (e.g., +300 BA Miles) or points scheme bonus (e.g., +120 Citibank Points). Furthermore, the ordered payment method list can identify a particular payment method as “recommended,” “most preferred,” “preferred,” “expected best,” “best value,” or “lowest total cost.” In embodiments in which the intelligent payment system 100 determines that one or more payment methods or the merchant or PoS under consideration exhibits a risk of fraud or reduced payment security (e.g., financial transaction data security), the ordered payment method list can further indicate a particular payment method as “safest,” or identify a payment method as “black listed,” “gray listed,” or “potential fraud/security risk.”

FIG. 4B is a schematic illustration of portions of another representative ordered payment method list, which can be presented by a payment method selection or transaction decision GUI, for the representative purchase at Retailer X. In addition or as an alternative to the foregoing, the ordered payment method list can include or specify for each payment method a corresponding total effective transaction savings or transaction premium or penalty amount (e.g., indicating a cost impact to the transaction of −$3.14 as a savings amount for a BA Premier Amex card, or +$1.05 as a premium amount for a Citibank Visa card), where the effective transaction savings or transaction premium amount can be correlated with, include, or account for an effective bonus or award currency value. The effective bonus or award currency value is the overall or cumulative value of one or more bonuses/awards for a given payment method, expressed in a reference or common currency unit. Thus, the indicated total effective transaction savings or transaction premium amount can be based upon, account for, or indicate a normalization or adjustment of bonus and/or award levels or amounts relative to a common or standard reference or benchmark unit of value (e.g., a common currency unit), in a manner such as that described above.

In some embodiments, a payment method selection or transaction decision GUI can provide details corresponding to criteria or factors that were used to determine the relative or comparative ordering, ranking, or scoring of the payment methods within the ordered payment method list for the transaction under consideration. For instance, the GUI can include a user selectable GUI element or icon such that the presentation of such details for any given payment method is performed in response to user input.

FIG. 4C is a schematic illustration of portions of a representative ordered payment method list, which can be presented by a payment method selection or transaction decision GUI, for a representative purchase at Retailer Y. In an embodiment, the GUI can provide a user selectable “i” icon associated with each payment method within the ordered payment method list. In response to user selection of a given “i” icon, the GUI can present particular payment method scoring information, data, or details. For example, for a CitiBank Plus Visa that provides a total transaction amount savings of −$13.30 for a $100.00 purchase at the retailer under consideration on the current date/time, the GUI can selectively indicate that this particular payment method is associated with a 15% discount and a +2% payment card fee. The GUI can also indicate a current or cumulative cost, cost savings, fee, and/or premium resulting from one or more criteria or factors (e.g., offers, rewards, currency-normalized or currency-adjusted bonus or reward amounts, exchange rate costs, overseas usage fees, etc. . . . ) that contributed to this payment method's relative ranking, ordering, or scoring. For example, the GUI can indicate a total transaction cost for the CitiBank Plus Visa of $86.70, and/or a corresponding discount amount of $13.30.

In a manner analogous to that described above, a payment method selection or transaction decision GUI can indicate for a given payment method a manner in which bonus and/or award levels or amounts were processed or accounted for relative to a common or standard reference or benchmark unit of value (e.g., a common currency unit) in association with a payment method selection process.

FIG. 4D is a schematic illustration of portions of another representative ordered payment method list, which can be presented by a purchase decision GUI, for the representative purchase at Retailer Y. As indicated in FIG. 4D, the ordering, ranking, or scoring of the CitiBank Plus Visa as the best or recommended payment method (e.g., the payment method providing the highest overall value or cost savings to the user) involved a 15% discount provided by Retailer Y (e.g., in accordance with particular discount or offer conditions, such as date/time conditions or expiry criteria), which reduces the purchase price to $85.00; a +2% payment card fee of $1.70; 150 Citi Miles bonus or award, valued at $0.0212 per mile, providing an effective discount or savings amount of $3.18; a Citi Miles loyalty penalty of 20% associated with Retailer Y, providing an effective premium or penalty amount of $0.64, for a total effective purchase price of $84.18 and a total effective value or savings to the user of $15.84.

### Aspects of Representative Analytics Data Collection/Processing/Provision

Analytics information, analytics data, or analytical data includes data collected, determined, processed, and/or provided as a result of payment method selection or decision making processes performed by an intelligent payment system 100 in accordance with an embodiment of the present invention. The processing or generation of analytical information or data can involve, for instance, the generation and analysis of statistical data corresponding to payment transactions and payment methods corresponding thereto by an intelligent payment system 100 in accordance with an embodiment of the present invention. Analytics information can be valuable to one or more individuals, entities, parties, or industries for a variety of reasons. When a transaction is executed, some or all of following information can be determined for analytics related purposes:
(a) At which merchant the transaction occurred, and on what date/time.
(b) What was purchased, and which brands were included in the purchase.
(c) What offers were available for the merchant or for the items purchased.
(d) Who made the transaction and further demographic information about the type of user.
(e) What cards or payment methods were available to the user making the transaction, including those not actually chosen to execute the transaction.
(f) What offers were available for the available payment methods.
(g) Which of the available payment methods were used.
(h) Various decision criteria involved in making the payment method selection, including some or each of:
   (i) Scoring of all available payment options for their total value
   (ii) Relevant user preferences affecting the decision criteria for the transaction
   (iii) Any charges for foreign transactions or card usage fees
   (iv) Foreign exchange rates to be applied for each payment method
   (v) Card or payment method acceptance information for the merchant or the transaction
   (vi) Value and type of transaction made
(h) Available offers for similar items are other PoS available to the user
(i) Is the user a repeat or regular customer at the PoS or merchant?
(j) Whether the user exercised an offer or incentive.
(k) Based on transaction history, whether the user was inclined to use the merchant due to an available offer.
(l) Whether the offer was a public or targeted offer for the user.
(m) Whether the offer was indicated to the user in advance or offered at the point of sale.
(n) Whether the user was aware of the offer in advance of the transaction, for example, indicating if this information was part of, or excluded from the purchase decision process.

Such information can be leveraged to provide data that is valuable, for instance, to the user, the merchant, a payment card provider, bank, loyalty scheme provider, and/or other institution, entity, or industry that may be interested in or find value in such data. For example, by way of provision of analytics information to users, such information can inform users of some or all of the following:
(a) A user can be informed of offers that are relevant to their regular spending habits or spending at retailers/PoS that they regularly use.
(b) The user can be informed of offers that are relevant to them and are located close to their location (e.g., current or home location).
(c) The user can be informed of available payment methods they do not own that could be available to them to better assist them in meeting their goals or increasing the rate at which they earn certain incentives.
(d) A user can be informed of payment methods available that will increase their cash flow or reduce their costs related to owning payment cards.
(e) A user can be informed of ways to reduce their interest payments or better manage their payment card balance.

With respect to merchants, the provision of analytics information to merchants can inform the merchant of some or each of the following:
(a) A merchant can be informed as to the relative or actual success of an offer or incentive. This can be in relation to previous offers of their own, or those of a competitor or associated party.
(b) A merchant can be informed as to the success of direct or indirect offer campaigns. For example, if a targeted offer is made to a group of users of the intelligent payment system 100 then data on which type or the number of users took advantage of the offer.
(c) The merchant can be informed as to why a given offer was successful or not, for example, if a competitor was also running a similar offer that was more attractive and users chose.
(d) The merchant can be informed if payment card selection was influenced by offers, partner schemes, or incentives, and how users or groups of users influenced that selection with profile preference data.
(e) The merchant can be informed or advised of offers they could consider that would be expected to be successful in light of the analytical data.

With respect to the provision of analytics information to payment card providers or financial institutions, such information can inform payment providers of one or more of the following:
(a) A payment card provider can be informed of demographics or percentages of users that own their card and also hold a competitor's card.
(b) A payment card provider can be informed of when a competitor's card was chosen for a given transaction over their own. Given that the intelligent payment system 100 has full visibility of the decision process, it can provide data as to exactly why a competitor's card was chosen for a given transaction.
(c) A payment card provider can be informed of percentages of users or other demographic data on holders of their cards who rarely use the provider's cards, preferring to use other cards or even cash. Full analytics on the reasoning behind competitive decisions are available due to the involvement of the intelligent payment decision engine in the payment method selection process.

With respect to the provision of analytics information to incentive providers or partners, such information can inform incentive partners of some or all of the following:
(a) Incentive partners can be informed as to how their incentive programs are competitive with others in the market. This information can be derived directly from real data from actual transaction providing far more accurate data than surveys. This data can also be provided faster, at greater scale, and without any interpretation by interviewers or data collection agents. This data may also be collected on a real time or near-real time basis.
(b) Incentive partners can be informed on relative value of their programs verses their competitors and can be informed on exactly the action required to become competitive in certain transactions. For example, specific information informing a incentive partner that by increasing their loyalty point return by 3% would have increased their relevance and would have resulted in their card being used in an additional 7.6% of transactions.

In addition to the foregoing, as analytics data can be retroactively queried and/or processed, simulated or test data can be produced based upon analytics data to test actual or proposed cards, offers, incentives, or the like against previous real transaction and transaction scoring, ranking, rating, or selection data to predict, forecast, or estimate a certain outcome (e.g., an expected comparative or relative payment method ordering, scoring, or ranking). For example, a payment card provider could approach a provider of an intelligent payment system 100 or a service associated therewith in accordance with an embodiment of the invention with one or more proposed cards, bonuses, offers, incentives, and/or target demographics. The intelligent payment system 100 can generate simulated data in based upon, correlated with, or in accordance with the proposed target demographic to estimate or demonstrate an expected level of success associated with the proposed cards, bonuses, offers, or incentives in the marketplace, relative to other cards, bonuses, offers, or incentives in the marketplace.

As analytics information in accordance with embodiments of the present invention is based upon or generated from information corresponding to or determined during payment method selection processes involving real transactions, real and/or simulated analytics information can provide the best analytics and/or forecasting data available to individuals, entities, or industries, such as one or more types of financial institutions or the payment card industry.

Analytics information can be generated, distributed, and/or utilized, and benefit be realized, without disclosing user identities or user payment data, as the name or personal details of users are not required to provide benefit. For example, a payment card provider may want to know that 26% of the customers of one of their cards also owns a certain competitor's card; or that for a given type of transaction or transaction location or demographic, their card is chosen only 12% of the time and 3 other competitive cards are chosen 18%, 34% and 36% respectively. As the scoring data is known with respect to why any one or more other cards were chosen (e.g., in view of an ordered ranking of payment methods within a payment method list), an intelligent payment system 100 can determine or estimate and a recipient of analytics data can be informed as to what would be required to be modified or pursued in order to gain a greater share of the market. This can occur without revealing customer information.

Similarly, a merchant can be informed as to what percentage of customers used a given offer, and what the decision processes were amongst those that didn't use the offer. Again, this can occur without ever needing the actual user information which protects the user.

Such analytical data about usage patterns is beneficial to the user as products, services, incentives and rewards may be tuned using this data to make them more competitive. This may improve the competitive landscape in the industry and ensure users get maximum value.

In addition, if a merchant or payment provider knows that they intelligent payment system 100 may not select their payment method for given transactions as they are not competitive. They may provide specific targeted offers or incentives to these users so their cards may be selected. This would be beneficial and advantageous to users of the intelligent payment system 100 who may receive additional incentives.

### Aspects of Representative Targeted or Responsive Offers/Incentives

Targeted offers or incentives can be automatically or semi-automatically generated by an intelligent payment system 100 in accordance with an embodiment of the present invention and distributed or provided to users in a way not previously possible. For example, if a user regularly eats with his family at a steak restaurant such as “Bill's Steakhouse” on Friday nights, the restaurant may know that he is a regular user. This may be hard to automatically track if he uses different payment methods. If the user stops eating at Bill's Steakhouse, the restaurant may not know why.

Using analytics information generated in accordance with an embodiment of the present invention, an intelligent payment system 100 can determine that the user has switched to “Bob's Grill” instead for his regular meal, for instance, due to a promotion, offer, bonus, lower cost, or other factor(s). Because the intelligent payment system 100 can analyze various aspects of the user's transaction history or purchase habits, the intelligent payment system 100 can determine that the user continues to eat steak on Fridays, and generate a targeted offer to the user for a Friday night at Bill's Steakhouse for a 25% discount in order to entice the user back to the original restaurant. In addition, data on the success of the offer is also available. As the offer can be valid using an e-voucher provided by the intelligent payment system 100, the user would need to use the system to receive the offer benefits, and this would mean the intelligent payment system 100 can determine whether the offer was a success.

Such offers and/or their success rate can be generated and distributed or targeted, again, without revealing personal information to the merchant. A merchant can simply be told that they have lost a percentage of customers to rivals in recent months, and that the intelligent payment system analytical data can be leveraged to try to recover the customers.

Similarly, if a user is known to buy products of a certain brand, then if an offer is going to be made available for this brand, the offer can be targeted at or tailored or customized to the user. Such targeting can be achieving using a variety of data, such as previous spending habits, previous patronage to retailers, data and time data, as well as data about the user's current location. For example, an offer for a particular clothing brand can be targeted at a consumer who regularly shops for this brand. If the user has shopped for the brand in the past but has stopped, then the offer can be used to entice them to again purchase the brand.

If a retailer has a need to raise their sales for a given period, for example, due to a high sales target, then time limited offers may be generated and delivered to targeted customers. For example, a targeted time limited offer can specify that a discount or additional discount is available between September 15^{th} and September 30^{th}. Such time limited targeting allows traditional sales to be more carefully targeted to specific demographics or customers, and allows users to learn of sales without needing to walk past a shop. As such, the generation and distribution of targeted offers, such as time limited offers, a much more intelligent and targeted approach to sales without the use of mass media, such as billboards or television campaigns. Promotions can also be more precisely or carefully targeted with only a subset of shoppers in a store getting sales prices based on targeted offers and electronic coupons.

Using location data, it is also possible to target offers to consumers based on their preferences, historic usage patterns and their possible payment options. For example, a restaurant can partner with a given payment card provider and offer a discounted lunch on a Monday, but only to known customers or customers fitting a certain demographic profile, who use a specific card and only if they are within a maximum distance or approximately the same geographic location as the restaurant.

In some embodiments, an intelligent payment system 100 can receive user input, requests, or queries that categorically or specifically identify user defined request or query criteria or preferences for particular items, products, goods, or services that the user is currently interested in purchasing. For instance, a user can decide that they want to eat, and can provide user input corresponding to an offer query or request directed to offers based on particular criteria that may be met by local restaurants. For example, the user may want offers for certain types of restaurants, and/or restaurants at which they have eaten more than twice in the last year to avoid receiving offers for restaurants that serve food they do not like. The user may further want to avoid traveling further than 10 km, and wants to eat within the next two hours. Such user wants can be indicated, included, specified or selected as part of the user defined criteria.

In response to an offer query or request, the intelligent payment system 100 can determine whether particular discounts, offers, bonuses, incentives, or the like exist at one or more merchants or PoS locations that satisfy the associated user defined criteria, and provide the user with the names and addresses of one or more local restaurants, and/or provide the user with one or more electronic offers or vouchers or references thereto (e.g., via e-mail).

The analytical data collected or generated in association with the resulting user purchase transaction is valuable as it is possible to identify whether an offer was successful but also, if it wasn't, did the user exercise a competitive offer and what was the offer chosen. Again, this is possible without identifying the actual user or revealing personal user details.

Targeted offers can also be made when a user travels. For example, a user may regularly travel to Melbourne, Australia; and eats in one of 10 different restaurants when in town. Those restaurants may be able to partner with an intelligent payment system 100 services provider so as to provide targeted offers, either automatically or at the users request, at one or more of the 10 restaurants that the user visits or can be expected to visit. This allows the user to get discount offers on places he regularly eats, and also allows the restaurants to compete for the user's business. The restaurant may or may not know who they are competing against, and may never learn the identity of the user in question, but analytics data can be provided as to the success of their offers.

The above description illustrates various embodiments of the present invention along with representative examples of how aspects of the present invention may be implemented. While specific embodiments have been described and illustrated it is understood that many changes, modifications, variations and combinations thereof could be made to the present invention without departing from the scope of the present invention. The above examples, embodiments, instructions semantics, and drawings should not be deemed to be the only embodiments, and are presented to illustrate the flexibility and advantages of the present invention as defined by the following claims:

1-77. (canceled)

78. A method of initiating a payment, the method comprising:
receiving a payment request generated at a Point-of-Sale (PoS) of merchant in association with a payment transaction between a user and the merchant;
selecting a payment method from a plurality of payment methods available to the user in response to the payment request based on payment evaluation criteria that includes a user-defined criteria corresponding to the plurality of payment methods and a server-defined criteria corresponding to the plurality of payment methods, the user-defined criteria including information related to user preferences with respect to the plurality of payment methods and the server-defined criteria including information related to terms associated with the plurality of payment methods; and
automatically initiating payment to the merchant with the selected payment method without requiring the user to acknowledge the payment method.

79. The method of claim 78, further comprising selecting the payment method at an electronic device of the user or a server accessible to the electronic device.

80. The method of claim 78, wherein the server-defined criteria comprises at least one of: discounts or offers available with respect to using a particular payment method, discounts, rebates, vouchers, bonuses, offers, or promotions available for the payment transaction, and at least one of merchant location information and merchant payment acceptance information.

81. The method of claim 78, wherein the user-defined criteria comprises at least one of: user-defined goals, spending limits, identified credit lines, interest rates, balance limits, user-defined payment rules, user-defined credit cards, user-defined debit cards, travel cards, payment vouchers, a spending target limit, a preferred reward type, a preference to increase cash flow for a payment method, interest rate and repayment date information corresponding to a payment method, a lowest cost card, a preference to use a bonus or introductory offer corresponding to a payment method, a preference to use a payment method that has a most value for money, a preference to balance usage of payment methods equally, a preference to use a payment method to maximize a credit score, and a preference to use a payment method that first meets user defined targets.

82. The method of claim 78, further comprising selecting the payment method based on PoS criteria that includes at least one of: a current user geographical location, a last known user geographical location, a date, a time, a currency, a type of transaction processor that is processing the payment transaction, a merchant offer, a merchant voucher, a merchant discount, a merchant advertisement, a history of previously preferred payment methods, a list of black listed locations, and information identifying whether the PoS is associated with fraud.

83. The method of claim 78, further comprising:
deriving a local rule set for an electronic device of the user from a server rule set that includes the server-defined criteria and the user-defined criteria; and
selecting the payment method using the local rule set when a remote server is inaccessible to the electronic device.

84. The method of claim 78, wherein selecting the payment method further comprises at least one of:
scoring possible payment methods according to the payment evaluation criteria;
converting a bonus or award amount associated with a particular payment method to an effective bonus or award currency value expressed in a reference currency unit;
generating an effective transaction cost that is correlated with an initial purchase price offset by the effective bonus or award currency value; and
determining whether the transaction corresponds to a business expense or a personal expense.

85. The method of claim 78, further comprising selecting the payment method based on the payment method providing at least one of a lowest cost and a best user value as determined based on the payment evaluation criteria.

86. The method of claim 78, further comprising selecting another payment method based on the payment evaluation criteria when the selected payment method fails in providing payment to the merchant.

87. The method of claim 78, further comprising:
determining whether another merchant is capable of providing a product or service associated with the payment transaction in accordance with a set of query criteria;
determining whether at least one offer or discount exists corresponding to the product or service; and
providing the user with merchant information corresponding to the at least one offer or discount.

88. The method of claim 78, further comprising providing the user with a list of recommended payment methods.

89. A computer-readable storage medium including instructions that cause a system to perform operations to initiate a payment, the operations comprising:
receiving a payment request generated at a Point-of-Sale (PoS) of merchant in association with a payment transaction between a user and the merchant;
selecting, at an electronic device of the user or a server accessible to the electronic device, a payment method from a plurality of payment methods available to the user in response to the payment request based on payment evaluation criteria that includes a user-defined criteria corresponding to the plurality of payment methods and a server-defined criteria corresponding to the plurality of payment methods, the user-defined criteria including information related to user preferences with respect to the plurality of payment methods and the server-defined criteria including information related to terms associated with the plurality of payment methods; and
automatically initiating payment to the merchant with the selected payment method without requiring the user to acknowledge the payment method.

90. The computer-readable storage medium of claim 89, wherein the server-defined criteria comprises at least one of: discounts or offers available with respect to using a particular payment method, discounts, rebates, vouchers, bonuses, offers, or promotions available for the payment transaction, and at least one of merchant location information and merchant payment acceptance information.

91. The computer-readable storage medium of claim 89, wherein the user-defined criteria comprises at least one of: user-defined goals, spending limits, identified credit lines, interest rates, balance limits, user-defined payment rules, user-defined credit cards, user-defined debit cards, travel cards, payment vouchers, a spending target limit, a preferred reward type, a preference to increase cash flow for a payment method, interest rate and repayment date information corresponding to a payment method, a lowest cost card, a preference to use a bonus or introductory offer corresponding to a payment method, a preference to use a payment method that has a most value for money, a preference to balance usage of payment methods equally, a preference to use a payment method to maximize a credit score, and a preference to use a payment method that first meets user defined targets.

92. The computer-readable storage medium of claim 89, further comprising selecting the payment method based on PoS criteria that includes at least one of: a current user geographical location, a last known user geographical location, a date, a time, a currency, a type of transaction processor that is processing the payment transaction, a merchant offer, a merchant voucher, a merchant discount, a merchant advertisement, a history of previously preferred payment methods, a list of black listed locations, and information identifying whether the PoS is associated with fraud.

93. The computer-readable storage medium of claim 89, wherein the operations further comprise:
deriving a local rule set for an electronic device of the user from a server rule set that includes the server-defined criteria and the user-defined criteria; and
selecting the payment method using the local rule set when a remote server is inaccessible to the electronic device.

94. The computer-readable storage medium of claim 89, wherein selecting the payment method further comprises at least one of:
scoring possible payment methods according to the payment evaluation criteria;
converting a bonus or award amount associated with a particular payment method to an effective bonus or award currency value expressed in a reference currency unit;
generating an effective transaction cost that is correlated with an initial purchase price offset by the effective bonus or award currency value; and
determining whether the transaction corresponds to a business expense or a personal expense.

95. The computer-readable storage medium of claim 89, wherein the operations further comprise selecting the payment method based on the payment method providing at least one of a lowest cost and a best user value as determined based on the payment evaluation criteria.

96. The computer-readable storage medium of claim 89, wherein the operations further comprise selecting another payment method based on the payment evaluation criteria when the selected payment method fails in providing payment to the merchant.

97. The computer-readable storage medium of claim 89, wherein the operations further comprise:
determining whether another merchant is capable of providing a product or service associated with the payment transaction in accordance with a set of query criteria;
determining whether at least one offer or discount exists corresponding to the product or service; and
providing the user with merchant information corresponding to the at least one offer or discount.

98. The computer-readable storage medium of claim 89, further comprising providing the user with a list of recommended payment methods.
